(19) United States
(12) Patent Application Publication
(10) Pub. No.: US 2009/0179424 A1
(43) Pub. Date: Jul. 16, 2009

(54) INTERNAL COMBUSTION ENGINE DRIVEN TURBO-GENERATOR FOR HYBRID VEHICLES AND POWER GENERATION

(75) Inventor: Ran Yaron, Boulder, CO (US)

Correspondence Address: FELIX L. FISCHER, ATTORNEY AT LAW, 1607 MISSION DRIVE, SUITE 204, SOLVANG, CA, 93463, US

(73) Assignee: INTERNAL COMBUSTION TURBINES LLC, Boulder, CO (US)

(21) Appl. No.: 12/353,902

(22) Filed: Jan. 14, 2009

Related U.S. Application Data
(60) Provisional application No. 61/010,989, filed on Jan. 14, 2008.
(60) Provisional application No. 61/065,080, filed on Feb. 9, 2008.
(60) Provisional application No. 61/066,037, filed on Feb. 15, 2008.

(51) Int. Cl. H02K 7/18; F04B 35/00; B60L 11/12

(52) U.S. Cl. 290/52; 417/364; 415/1; 123/65 R; 180/65.245

(57) ABSTRACT

A piston compression system converts energy from a conventional combustion cycle engine driving a piston to displace a working gas for flow through a turbine for output power. The working gas is derived by diverting a portion of the charge during combustion at near peak combustion pressure (PCP) into a closed working volume. The working gas is maintained at high pressure within the working volume. The working volume has a first displacement compartment and a second displacement compartment, a supply manifold connected for receiving pressurized working gas alternately from the first and second compartments and connected to an inlet of the turbine, and a return manifold connected to an outlet of the turbine and alternately returning working gas to the second and first compartments. The engine is configured with first and second pistons housed in first and second combustion cylinders respectively powering a first displacing surface for displacement of working gas in the first compartment and a second displacing surface for displacement of working gas in the second compartment.

### REFERENCE TO RELATED APPLICATIONS

This application claims priority of U.S. Provisional applications Ser. No. 61/066,037 filed on Feb. 15, 2008 entitled Internal Combustion Turbine, Ser. No. 61/010,989 filed on Jan. 14, 2008 entitled Gas-bearings Generators and Ser. No. 61/065,080 filed on Feb. 9, 2008 entitled Crankless Engine, all having a common inventor with the present application, the disclosure of each provisional being fully incorporated herein by reference as though fully set forth.

### BACKGROUND

1. Field

This invention relates generally to the field of internal combustion engines for electrical power generation and more particularly to a linear piston internal combustion engine providing displacement of a working gas for driving a low pressure ratio turbine.

2. Description of the Related Art

Piston driven internal combustion engines typically require conversion of linear motion of one or more pistons to rotational motion of a crankshaft through the use of connecting rods. In a standard engine the forces applied by the expanding gas in the combustion chamber are converted to a force on the connecting rod that is not parallel to the cylinder axis for the majority of its motion resulting in substantial side forces and friction. To avoid the efficiency loss resulting from this conversion a number of engine designs have been created employing linear or “free piston” motion. In a free piston engine the combustion pressure is converted to axial motion without any side force component, thereby achieving increased transfer of driving forces. However, there are still a few challenges which plague free piston engines including preventing the piston from hitting the cylinder head, controlling valves for inlet and exhaust, and converting the linear piston motion to a power output. Conversion of free piston motion to rotational motion of a shaft using cam driven arrangements or direct gearing such as a rack and pinion has been employed in certain designs such as those disclosed by Revetec, 10/507 Olsen Avenue, Ashmore, Qld, Australia, 4214.

In attempting to achieve greater efficiency many internal combustion engines are now coupled with electrical power generators for actual output power from the engine. Ordinary crankshaft internal combustion engines are limited in revolution speed to approximately 6000 to 8000 rpm for reasonable trade off between engine life and power output. While rotational speed can be increased somewhat by use of gearing, generators which are coupled to an internal combustion engine typically must be designed for relatively low rotational speed. Low speed generators require larger size and more materials including copper, steel and magnets than high speed generators. Consequently, such low speed generators are significantly more expensive. In addition the electronics required for conversion of low frequency AC output from an electrical generator employed with a conventional internal combustion engine necessary for conversion to direct current applications is expensive for low frequency designs. Linear piston engines have been developed for use with linear electrical generators such as disclosed in “Towards a Linear Engine”, Michael Anthony Prados, Engineer Thesis, Stanford University, May 2002 and “Development of a linear alternator-engine for hybrid electric vehicle applications”, Cawthorne, W. R. Famouri, P. Jingdong Chen Clark, N. N. McDaniel, T. I. Atkinson, R. J. Nandkumar, S. Atkinson, C. M. Petreanu, S., Vehicular Technology, IEEE Transactions, November 1999, Volume: 48, Issue: 6, page(s): 1797-1802. Linear generators/alternators in this form require large magnet mass which must oscillate thereby increasing inertia and reducing efficiency. The size, mass and cost of such linear generators are large due to the slow oscillations speed. The mechanical to electrical conversion efficiency is limited due to edge effects on the magnetic circuit and due to the fact that the speed of motion and available force are variable. Linear generators/alternators have not yet been developed which provide consistent regulatable power output. Rotating generators/alternators provide the most efficient and fully developed means for electrical power generation. In applications where a electrical power output is desirable significant efficiency improvements can be provided for powering of rotating generators/alternators with a turbine allowing operation at higher rotational speed and thus reducing size.

### SUMMARY

The embodiments disclosed herein provide a power generation system incorporating a displacement volume for a working gas with a turbine interconnected to the displacement volume. An engine is employed having at least one piston housed in a combustion cylinder with motion of the piston in reaction to combustion of a charge displacing the working gas in the displacement volume for flow through the turbine. The working gas is derived by diverting a portion of the combusted charge in the cylinder at near peak combustion pressure (PCP) into the displacement volume.

In an exemplary embodiment, the displacement volume has a first displacement compartment and a second displacement compartment, a supply manifold connected for receiving pressurized working gas alternately from the first and second compartments and connected to an inlet of the turbine, and a return manifold connected to an outlet of the turbine and alternately returning working gas to the second and first compartments. The engine is configured with first and second pistons housed in first and second combustion cylinders respectively powering a first displacing surface for displacement of working gas in the first compartment and a second displacing surface for displacement of working gas in the second compartment.

In one embodiment, the pistons are connected by a rod and the first and second compartments are incorporated in a displacement cylinder. The first and second displacing surfaces are the opposing faces of a displacement piston connected to the rod and carried within the displacement cylinder.

In a second embodiment, the first displacing surface is a backside of a first of the two pistons and the second displacing surface is a backside of a second of the two pistons. The first and second displacement compartments are the combustion cylinder sumps for the first and second pistons.

One aspect of various embodiments incorporates a conduit interconnecting a combustion chamber for one of the pistons with at least one of the first or second compartments through a unidirectional valve. A gas conditioning system is integrated with the conduit for conversion of combustion products from the combustion chamber into working gas.

A method for power generation is demonstrated with the embodiments where combusting a charge in a cylinder drives a piston. The piston motion is used to displace a working gas and the displaced working gas is provided to a turbine inlet.

In one aspect of the method, a portion of the combusted charge is extracted at near peak combustion pressure (PCP) as the working gas.

The method provided by the embodiments allows the turbine to operate at a pressure ratio of less than 1.5.

The embodiments disclosed herein provide the desirable effect of combining the efficiency of a linear piston engine and turbine driven electrical generator as an integrated operating system for increased electrical system efficiency and reduced cost and size. The embodiments also provide a linear piston engine which prevents cylinder head contact and reduces lubrication and alignment requirements.

### BRIEF DESCRIPTION OF THE DRAWINGS

These and other features and advantages of the present invention will be better understood by reference to the following detailed description of exemplary embodiments when considered in connection with the accompanying drawings wherein:

FIG. 1 is a schematic representation of a general arrangement of a first embodiment of the invention employing a two-stroke combustion cycle;

FIG. 2 is a schematic representation of a second embodiment of the invention employing a 4-stroke combustion cycle;

FIG. 3 is a schematic representation of a third embodiment of the invention;

FIGS. 4A-4D demonstrate the combustion cycles for a forth embodiment of the invention employing 4-stroke combustion cycle with two turbines;

FIGS. 5A-5D demonstrate the combustion cycles for a fifth embodiment of the invention employing a 4-stroke combustion cycle with active valving for a single turbine;

FIG. 6 is a schematic representation of an air bearing system incorporated in the embodiment of FIG. 3;

FIG. 7 is a schematic section view of one exemplary piston showing the implementation of the air bearing conduits;

FIG. 8 is a partial schematic view of the embodiment of FIG. 2 demonstrating a pressure pad plenum to prevent bottoming of the piston assembly;

FIG. 9 is a schematic representation of additional operating elements of the embodiments;

FIG. 10 is an exemplary embodiment employing a conventional crank engine using the piston pressure sumps as displacement volumes to provide working gas to the turbine;

FIG. 11 is a performance map for an exemplary turbine employed with an embodiment as described; and,

FIG. 12 is an exemplary use of the embodiments herein for a hybrid electric car.

### DETAILED DESCRIPTION

Embodiments shown in the drawings and described herein provide an engine using a piston compression system converting energy from a conventional combustion cycle driving a piston which displaces a working fluid to flow through a turbine for output power generation. For certain of the embodiments shown, the working fluid is a working gas derived by diverting a portion of the charge during combustion at near peak combustion pressure (PCP) into a closed working volume. The working gas is maintained at high pressure within the working volume. Various embodiments are disclosed herein employing two and four pistons with both two-stroke and 4-stroke combustion cycles. The exemplary embodiments may employ gasoline, diesel, natural gas, propane, methane or hydrogen or other suitable combustible material as the combustion fuel with associated injection and ignitions system as required for the chosen cycle.

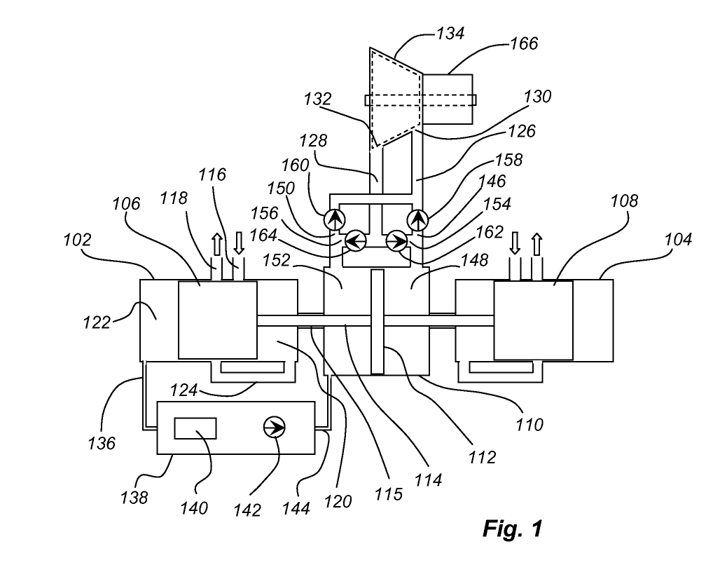

Referring to the drawings, a detailed schematic of a first embodiment of the present invention is shown in FIG. 1. Two linearly opposed combustion cylinders 102 and 104 house drive pistons 106 and 108 respectively to provide an internal combustion section for the engine. A displacement cylinder 110 resides intermediate the combustion cylinders and houses a displacement piston 112. Connecting rod 114 interconnects the first and second drive pistons with the displacement piston for reciprocating motion. In alternative embodiments the connecting rod may be configured as two separate rods interconnecting the first and second drive pistons with the displacement piston. Conduits 115 provide passage for the connecting rod between pressurization sumps 120 and displacement cylinders.

For the two-stroke combustion cycle embodiment shown in FIG. 1, each combustion cylinder incorporates an inlet port 116 and an outlet port 118. A pressurization sump 120 for the inlet charge is connected to combustion chamber 122 through a transfer port 124. Spark plugs and other fuel/ignition components are not shown in the drawing for clarity of the other operating features but are employed as known in the art for embodiments employing a gasoline (Otto) cycle.

Displacement cylinder 110 is filled with a working gas and connected through supply manifold 126 and return manifold 128 to the inlet 130 and outlet 132 of a turbine 134. For the embodiment shown in FIG. 1, working gas for the displacement cylinder is provided by extracting combusted gas from one of the combustion cylinders. For the embodiment shown in FIG. 1, conduit 136 integral with or porting from the cylinder head extracts a bleed flow of combusted gas and routes it to a conditioning unit 138. The conditioning unit incorporates a heat exchanger 140 which cools the gas to near ambient temperature and a check valve 142 to prevent backflow into the combustion chamber. In exemplary embodiments, the check valve is adjustable to control pressure in the working gas volume and may be actively controlled for start-up or transient conditions as will be described in greater detail subsequently. Alternatively, a directional valve may be used instead of a check valve. A dryer for removal of water or other condensate and a filter for trapping solids (not shown) may also be provided as a portion of the conditioning unit. Additional components for treatment of the combustion gas to absorb, trap or catalytically treat unwanted exhaust byproducts to provide the desired quality for the working gas may also be employed. The purified working gas is provided through conduit 144 to the displacement cylinder.

In Diesel cycles the PCP can vary between about 5 and 10 MPa (750-1,500 psi) depending on the temperature and pressure of the compressed air and the air to fuel mixing ratio. In an Otto (gasoline) cycle PCP is about 4 MPa (600 psi). Working gas supplied to the displacement cylinders will have slight losses due to pressure drop through the conduit and conditioning system but will maintain a pressure substantially near PCP. Working gas pressures for the embodiments disclosed herein may range from about 3.3 MPa (500 psi) to 10 MPa (1500 psi).

Displacement cylinder 110 provides displaced working gas to turbine 134 through supply manifold 126 and a return manifold 128 returns the working gas discharged from the turbine. The supply manifold incorporates a supply port 146 to receive working gas from a first compartment 148 of the displacement cylinder which is displaced by a first displacing surface of the displacement piston 112 and a second supply port 150 to receive working gas from a second compartment 152 which is displaced by a second displacing surface of the displacement piston 112. Similarly the return manifold incorporates a first return port 154 associated with the first compartment and a second return port 156 associated with the second compartment. The supply manifold incorporates unidirectional valves 158 and 160 to prevent backflow into the displacement cylinder through supply ports 146 and 150. The return manifold incorporates unidirectional valves 162 and 164 to prevent outflow from the displacement cylinder into the return manifolds. The combined valve arrangement in the supply and return manifolds provides unidirectional flow of working gas through the turbine. The working gas is maintained at high pressure within the closed working volume created by the displacement cylinder, supply and return manifolds and the turbine. Motion of the displacement piston driven by the reciprocating combustion pistons provides the flow of high pressure working gas to the turbine. The high pressure of the working gas, near PCP, does not hinder the operation of the high pressure combustion expansion cycle and the low pressure exhaust/intake cycle of the combustion pistons since the net force applied on displacement piston 112 is the difference of the pressure at the first compartment 148 and second compartment 152 applied on the displacement piston 112 area. The pressure of the working gas in first compartment 148 and second compartment 152 is near PCP but the difference in pressure between the compartments is relatively small. This difference is developed dynamically when displacement piston 112 reciprocates.

In operation, firing of the first combustion cylinder 102 with resulting motion of the first drive piston 106 urges the displacement piston 112 through rod 114 to reduce the volume in the first compartment 148 of the displacement cylinder driving working gas through supply port 146 into the supply manifold 126. Working gas driven into the manifold is supplied to turbine inlet 130 to drive the turbine 134. The discharged working gas from the turbine exiting outlet 132 is returned through the return manifold 128 into return port 156 in the second compartment 152 of the displacement cylinder 110. Displacement of the first drive piston 106 due to its combustion expansion also provides compression of the second drive piston 108 within the second combustion cylinder 104 through rod 114. Firing of the second combustion cylinder 104 then reverses the direction of motion of the displacement piston 112 resulting in a reduction in volume in the second compartment 152 of the displacement cylinder by the displacement piston driving working gas through supply port 150 to the turbine with discharged working gas returning through return port 154. The assembly created by the drive pistons and displacement piston connected in an axially rigid manner by the rod oscillates linearly in response to alternating combustion in the two combustion cylinders.

Turbine 134 for the embodiment shown is an impeller type turbine. While operating in a high pressure environment of about 4 MPa (600 psi) to 10 MPa (1500 psi), the turbine operates at low pressure ratio (low differential pressure) of approximately 1.1 to 1.2 resulting in high efficiency operation as will be described subsequently based on preliminary test results. The turbine operates at essentially ambient temperature and therefore employs common materials such as aluminum, composites or even plastic. For the embodiments shown and described herein generation of shaft power in the range of 1-100 kW is expected with anticipated turbine speed of approximately 150,000 to 15,000 rpm respectively and provides power to a high speed rotating electrical generator 166. The high turbine speed allows use of a generator for electrical power generation operating at a frequency of 15,000 rpm or greater with direct connection to the turbine. In alternative embodiments the shaft power generation of the turbine may be employed for direct rotational drive for devices such as water pumps, marine or aircraft propellers or vehicle wheels.

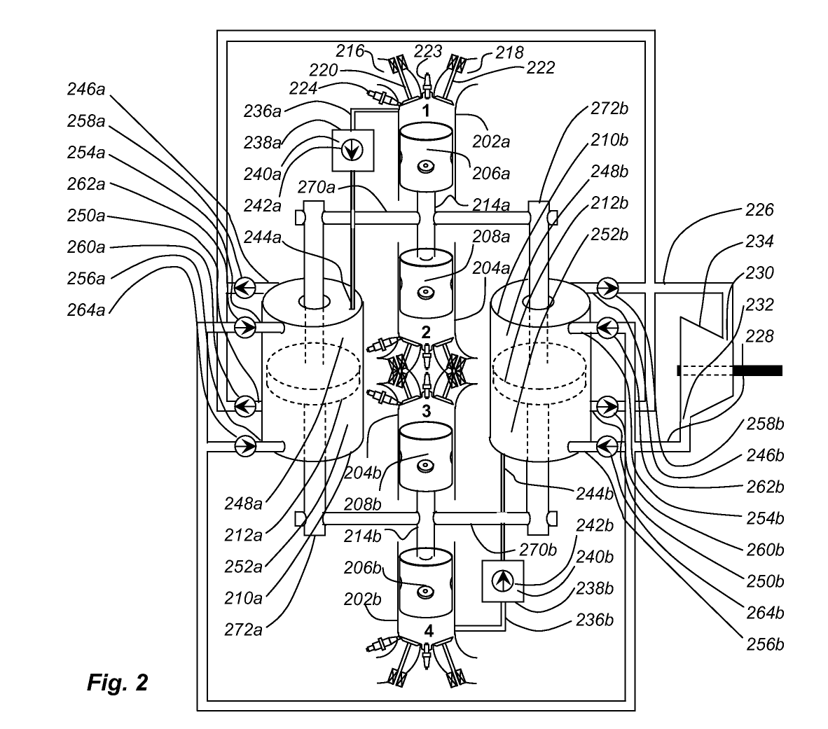

In certain applications a four-stroke combustion cycle may be desirable. FIG. 2 shows a second embodiment of the invention which employs a four-stroke cycle with two cylinder and piston pairs coupled with two displacement cylinders. Two linearly opposed combustion cylinders 202a and 204a are employed to house drive pistons 206a and 208a respectively. Similarly, two linearly opposed combustion cylinders 202b and 204b are employed to house drive pistons 206b and 208b respectively. The pairs of cylinders are axially aligned for the embodiment shown in the drawings. Two displacement cylinders 210a and 210b reside symmetrically adjacent and axially parallel to the combustion cylinders and each houses a displacement piston 212a and 212b respectively. Connecting rods 214a and 214b linearly interconnect the first and second drive pistons in each set with the displacement pistons driven by lateral rods 270a and 270b perpendicularly extending from the connecting rods and driving parallel rods 272a and 272b interconnecting the displacement pistons for reciprocating motion. The symmetrical attachment of the parallel rods avoids radial forces being induced in the connecting rods which might affect the linear motion. For the four-stroke combustion cycle embodiment shown in FIG. 2, each combustion cylinder incorporates an inlet port 216 and an outlet port 218 with associated inlet solenoid valves 220 and exhaust solenoid valves 222. Spark plugs 223 and fuel injectors 224 provide conventional four-stroke fuel injection and ignition.

Each displacement cylinder is filled with working gas and connected through supply manifolds 226 and return manifold 228 to the inlet 230 and outlet 232 of a turbine 234. For the embodiment shown in FIG. 2, working gas for the displacement cylinders is provided by extracting combustion gas from one or more of the associated combustion cylinders. Conduit 236a extracts a bleed flow of combustion gas and routes it to a conditioning unit 238a. The conditioning unit incorporates a heat exchanger 240a which cools the gas to near ambient temperature and a check valve 242a to prevent backflow into the combustion cylinder. Similarly, Conduit 236b extracts a bleed flow of combustion gas and routes it to a conditioning unit 238b. The conditioning unit incorporates a heat exchanger 240b which cools the gas to near ambient temperature and a check valve 242b to prevent backflow into the combustion cylinder. As for the prior embodiment, dryers for removal of water or other condensate and filters for trapping solids are also provided. Additional components for treatment of the combustion gas to absorb, trap or catalytically treat unwanted exhaust byproducts to provide the desired quality for the working gas may also be employed. The purified working gas is provided through conduits 244a and 244b to the displacement cylinders.

The displacement cylinders provide pressurized working gas to turbine 234 through supply manifold 226 and a return manifold 228 returns the working gas discharged from the turbine. Supply manifold 226 incorporates supply ports 246a and 246b to receive working gas from a first compartment in each displacement cylinder, 248a and 248b respectively, which is pressurized by a first displacing surface of each displacement piston and second supply ports 250a and 250b to receive working gas from a second compartment in each displacement cylinder, 252a and 252b respectively, which are pressurized by a second displacing surface of each displacement piston. Similarly the return manifold incorporates first return ports 254a and 254b in the respective first compartments and second return ports 256a and 256b in the respective second compartments. The supply manifold incorporates unidirectional valves 258a, 258b, 260a and 260b to prevent backflow into the displacement cylinders through supply ports 246a, 246b, 250a and 250b. The return manifold incorporates unidirectional valves 262a, 262b, 264a and 264b to prevent outflow from the displacement cylinders into the return manifold. The combined unidirectional valve arrangement in the outlet and return manifolds provides unidirectional flow of working gas through the turbine. The operation of the embodiment in FIG. 2 is similar to the operation of the embodiment shown and described with respect to FIG. 1, with the difference that one of the four combustion cylinders is powered in each stroke of the 4 stroke engine.

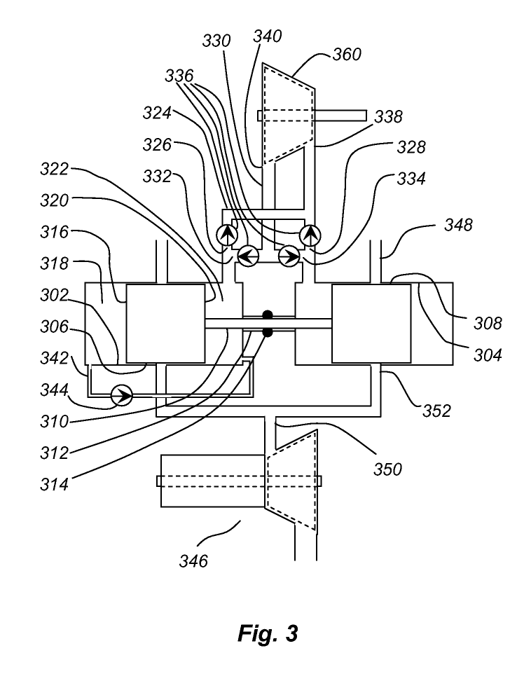

FIG. 3 schematically demonstrates a third embodiment employing a two-stroke cycle wherein the volumes associated with the combustion cylinders as pressurization sumps in the embodiment of FIG. 1 act as the working gas displacement compartments for the engine. The faces of the drive piston opposite the combustion surface in the combustion chamber provide the function of the displacing surfaces of the displacement piston in the embodiment of FIG. 1. A first cylinder 302 and a second cylinder 304 house a first piston 306 and a second piston 308. A connecting rod 310 interconnects the two pistons. Each piston has a combustion surface 316 exposed to the combustion chamber 318. A displacing working surface 320 on a face of each piston opposite the combustion surface operates in a displacement compartment 322. For the configuration shown in FIG. 3 the displacement compartments are interconnected by a channel 312 for passage of the connecting rod with appropriate sealing gaskets 314 to prevent working gas communication directly between the two displacement compartments. As with the prior embodiments the displacement compartments associated with each cylinder provide working gas through a supply manifold 324 having supply ports 326 and 328 in the two displacement compartments. Return manifold 330 returns working gas to the displacement compartments through return ports 332 and 334. Directional flow valves 336 are associated with each supply port and return port to provide unidirectional flow of the working gas through the turbine 360 via turbine inlet 338 and turbine outlet 340 connected to the supply and return manifolds respectively.

As with the previously disclosed embodiment, working gas for the displacement compartments is provided through a bleed conduit 342 to a conditioning unit 344 for introduction of the gas into the displacement compartments. For the embodiment shown a single conduit in one of the cylinder assemblies is employed. In alternative embodiments to assure symmetry of the pressurization system for starting conditions a mirrored bleed system is provided on the second cylinder.

To replace inlet charge pressurization previously provided by the pressurization sump in the first embodiment, an electrically driven compressor 346 provides fresh pressurized air through an inlet manifold 350 to inlet ports 352 in the combustion cylinders. Alternatively, a turbocharger receives exhaust gas from the combustion cylinders through exhaust outlets 348 and provides fresh pressurized air to the inlet manifold. Gasoline direct injection (GDI) for two-stroke internal combustion applications may be employed with the present invention as disclosed. Spark plugs are not shown in the drawing for clarity of other components but are employed as known in the art for gasoline cycle embodiments.

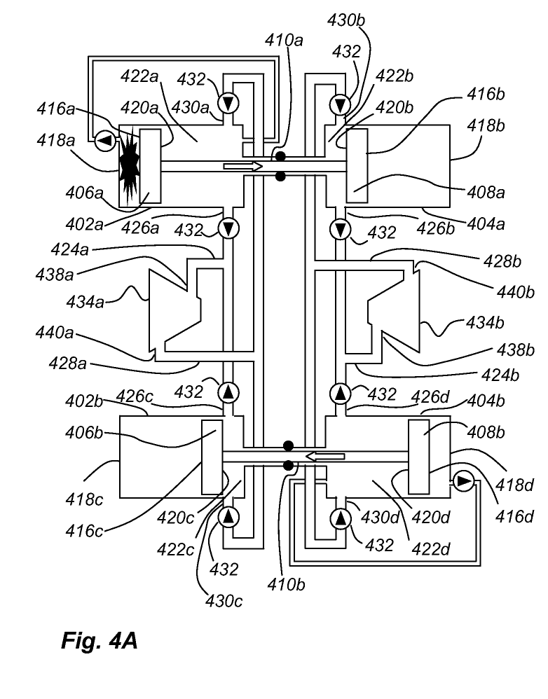

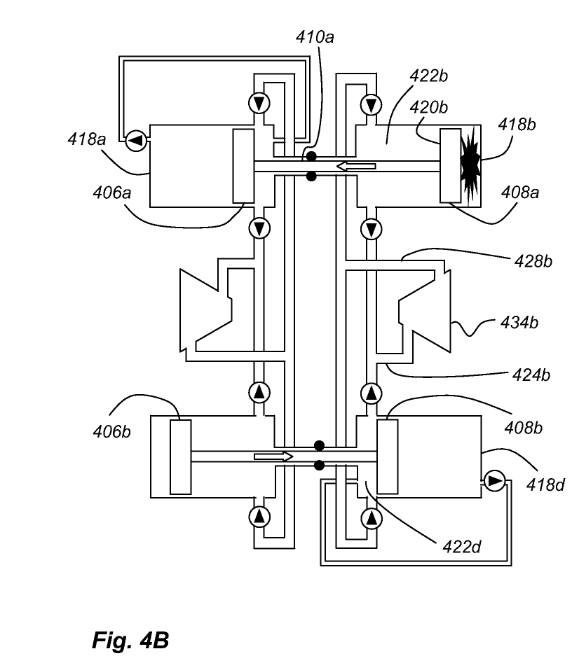

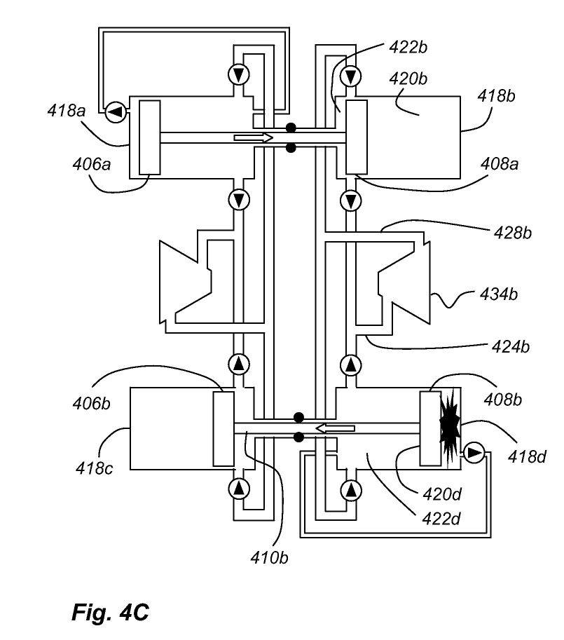

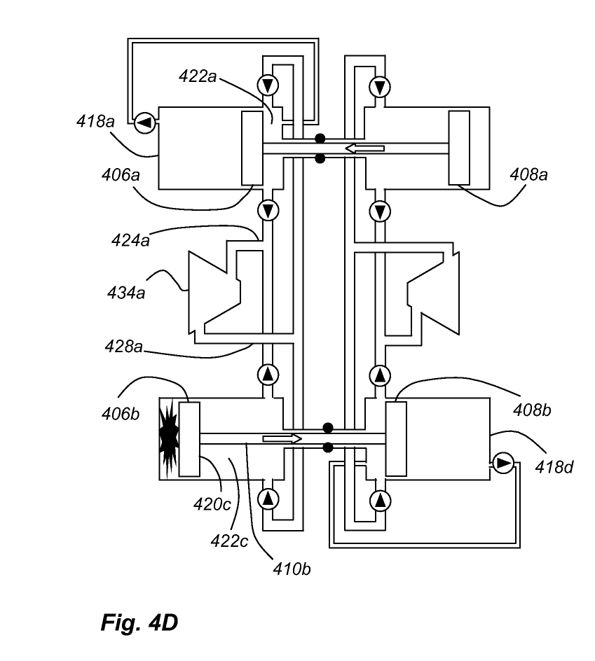

FIGS. 4A through 4D demonstrate the combustion sequence of a 4-stroke embodiment of the present invention employing two linear piston sets with the combined combustion cylinders and displacement compartments, as in the two-stroke embodiment described with respect to FIG. 3, providing working gas to two turbines with cross manifolding between the piston sets. The turbines may share a common shaft for power output. Inlet and outlet valves, fuel injectors and spark plugs are not shown in the drawings for clarity of the other operating features but are employed as known in the art.

A first cylinder 402a and a second cylinder 404a house a first piston 406a and a second piston 408a. A third cylinder 402b and a fourth cylinder 404b house a third piston 406b and a fourth piston 408b. Connecting rods 410a and 410b linearly interconnect the two pistons in each piston pair. Each piston has a combustion surface 416a, 416b, 416c and 416d exposed to the combustion chamber 418a, 418b, 418c and 418d. A compression working surface 420a, 420b, 420c and 420d on a face of each piston opposite the combustion surface operates in a displacement compartment 422a, 422b, 422c and 422d. As with the prior embodiments the displacement compartments associated with each cylinder provide working gas through a supply manifold. For the embodiment shown in FIGS. 4A-4D, two supply manifolds 424a and 424b have supply ports 426a, 426b, 426c and 426d respectively. The supply ports for each supply manifold are located in two displacement compartments associated with consecutively firing cylinders associated with different piston pairs resulting in cross manifolding for driving of two turbines. Return manifolds 428a and 428b return working gas to the displacement compartments through return ports 430a, 430b, 430c and 430d respectively. Directional flow valves 432 are associated with each outlet port and return port to provide unidirectional flow of the working gas through turbines 434a and 434b via turbine inlets 438a and 438b and turbine outlets 440a and 440b connected to the supply and return manifolds respectively.

The operational sequence of the four-stroke cycle shown by FIGS. 4A through 4D begins with combustion of the charge mixture in combustion chamber 418a as shown in FIG. 4A. Piston 406a is driven to the right with displacing surface 420a displacing the working gas in displacement compartment 422a. The working gas is received in supply manifold 424a and provided to the inlet of turbine 434a. The working gas discharged from the turbine is received in return manifold 428a which returns the gas to displacement compartment 422c. Entry of pressurized working gas into displacement compartment 422c causes piston pair 406b and 408b to be driven to the left resulting in intake of charge air into combustion chamber 418d. Piston 408a driven to the right by connecting rod 410a compresses the charge in combustion chamber 418b.

The second firing stroke shown in FIG. 4B commences with combustion of the charge mixture in combustion chamber 418b. Piston 408a is driven to the left with displacing surface 420b displacing the working gas in displacement compartment 422b which is received in supply manifold 424b and provided to the inlet of turbine 434b. The working gas discharged from the turbine is received in return manifold 428b which returns the gas to displacement compartment 422d. Entry of pressurized working gas into displacement compartment 422d causes piston pair 406b and 408b to be driven to the right resulting in compression of charge air in combustion chamber 418d. Piston 406a driven to the left by connecting rod 410a creates the exhaust stroke for combustion chamber 418a.

The third firing stroke shown in FIG. 4C commences with combustion of the charge mixture in combustion chamber 418d. Piston 408b is driven to the left with displacing surface 420d displacing the working gas in displacement compartment 422d which is received in supply manifold 424b and provided to the inlet of turbine 434b. The working gas discharged from the turbine is received in return manifold 428b which returns the gas to displacement compartment 422b. Entry of pressurized working gas into displacement compartment 422b causes piston pair 406a and 408a to be driven to the right resulting in an exhaust cycle for combustion chamber 418b and intake of charge air in combustion chamber 418a. Piston 406b driven to the left by connecting rod 410b creates a compression stroke for combustion chamber 418c.

In the fourth firing stroke as shown in FIG. 4D, piston 406b is driven to the right with displacing surface 420c displacing the working gas in displacement compartment 422c which is received in supply manifold 424a and provided to the inlet of turbine 434a. The working gas discharged from the turbine is received in return manifold 428a which returns the gas to displacement compartment 422a. Entry of pressurized working gas into displacement compartment 422a causes piston pair 406a and 408a to be driven to the left resulting in compression of charge air in combustion chamber 418a. Piston 408b driven to the right by connecting rod 410b creates the exhaust stroke in combustion chamber 418d.

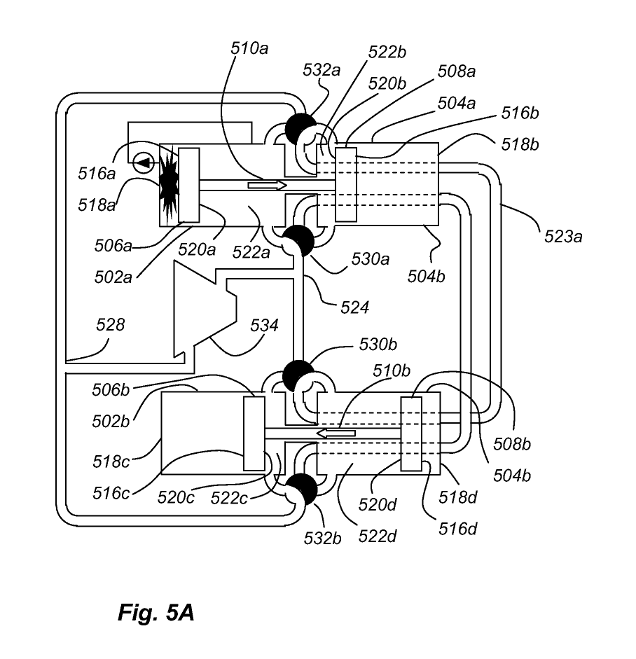

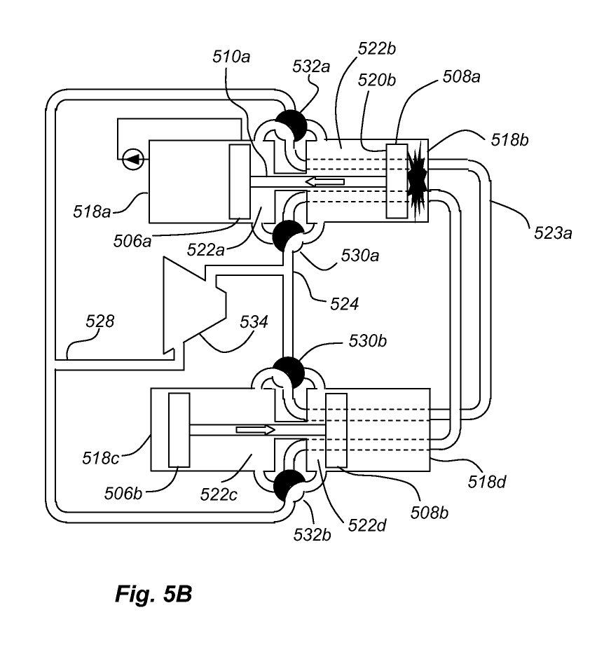

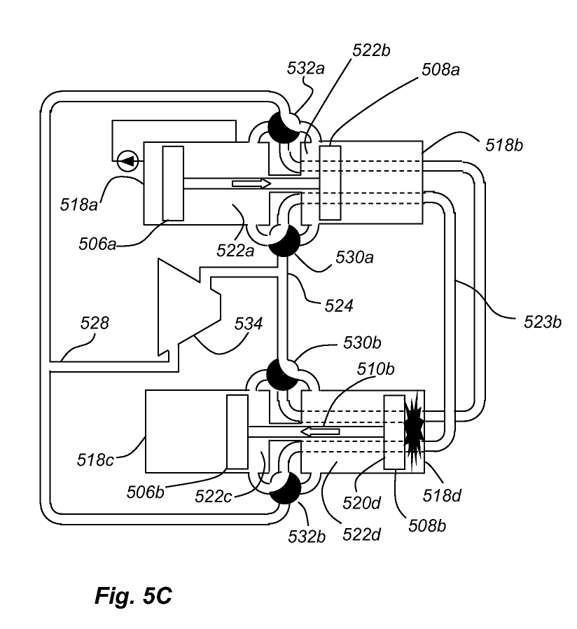

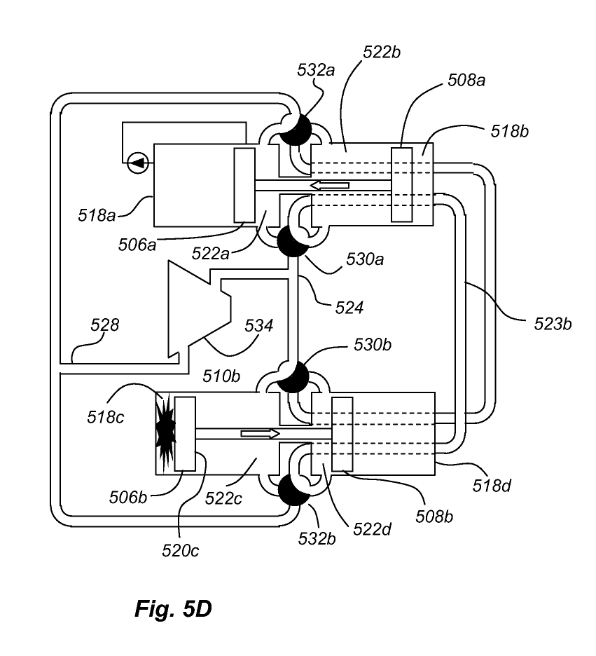

FIGS. 5A through 5D demonstrate the combustion cycles of a 4-stroke embodiment of the present invention again employing the two linear piston sets but with active valving to provide working gas to a single turbine. Inlet and outlet valves, fuel injectors and spark plugs are not shown in the drawings for clarity of the other operating features but are employed as known in the art.

A first cylinder 502a and a second cylinder 504a house a first piston 506a and a second piston 508a. A third cylinder 502b and a fourth cylinder 504b house a third piston 506b and a fourth piston 508b. Connecting rods 510a and 510b linearly interconnect the two pistons in each piston pair. Each piston has a combustion surface 516a, 516b, 516c and 516d exposed to the combustion chamber 518a, 518b, 518c and 518d. A compression working surface 520a, 520b, 520c and 520d on a face of each piston opposite the combustion surface operates in a displacement compartment 522a, 522b, 522c and 522d. As with the prior embodiments the displacement compartments associated with each cylinder provide working gas through a supply manifold. Unlike the embodiment disclosed in FIGS. 4A-4D, however, a single supply manifold 524 receives pressurized working gas from the displacement compartments and a single return manifold 528 returns the working gas. Actively controlled supply valves 530a and 530b and return valves 532a and 532b alternately connect the manifolds to the supply and return ports in the displacement compartments or to neutral passthrough conduits for pressure transfer in non-firing cylinders.

The operational sequence of the four-stroke cycle shown by FIGS. 5A through 5D begins with combustion of the charge mixture in combustion chamber 518a as shown in FIG. 5A. Piston 506a is driven to the right with displacing surface 520a displacing the working gas in displacement compartment 522a. Active valve 530a is in a first position connecting the supply manifold to displacement compartment 522a allowing working gas from displacement compartment 522a into the supply manifold 524 and then to the inlet of turbine 534. The working gas discharged from the turbine is received in return manifold 528. Active valve 532b is in a first position connecting the return manifold to displacement compartment 522c which returns the gas to displacement compartment 522c. Entry of pressurized working gas into displacement compartment 522c causes piston pair 506b and 508b to be driven to the left resulting in intake of charge air into combustion chamber 518d. Piston 508a driven to the right by connecting rod 510a compresses the charge in combustion chamber 518b. Active valves 532a and 530b are in a first neutral position directly connecting displacement compartments 522b and 522d through conduits 523a. Motion of piston 508a to the right causes a pressure reduction in displacement compartment 522b which in turn creates a reduced pressure in displacement compartment 522d assisting in transition of piston 508b to the left.

The second firing stroke shown in FIG. 5B commences with combustion of the charge mixture in combustion chamber 518b. Piston 508a is driven to the left with displacing surface 520b displacing the working gas in displacement compartment 522b. Active valve 530a is now in a first position connecting displacement compartment 522b to the supply manifold 524 which receives the working gas and provides it to the inlet of turbine 534. The working gas discharged from the turbine is received in return manifold 528. Active valve 532b is now in a first position connecting displacement compartment 522d to the return manifold which returns the working gas to displacement compartment 522d. Entry of pressurized working gas into displacement compartment 522d causes piston pair 506b and 508b to be driven to the right resulting in compression of charge air in combustion chamber 518d. Piston 506a driven to the left by rod 510a creates the exhaust stroke for combustion chamber 518a. Active control valves 532a and 530b are in a second neutral position directly connecting displacement compartments 522a and 522c through conduit 523a. A reduction in pressure in displacement compartment 522a due to motion of the piston to the left results in a reduced pressure in displacement compartment 522c assisting in transition of piston 506b to the right.

The third firing stroke shown in FIG. 5C commences with combustion of the charge mixture in combustion chamber 518d. Piston 508b is driven to the left with displacing surface 520d displacing the working gas in displacement compartment 522d. Active valve 530b is now in a second position connecting displacement compartment 522d to the supply manifold 524 which provides the working gas to the inlet of turbine 534. The working gas discharged from the turbine is received in return manifold 528. Active valve 532a is now in a second position connecting displacement compartment 522b to the return manifold which returns the working gas to displacement compartment 522b. Entry of pressurized working gas into displacement compartment 522b causes piston pair 506a and 508a to be driven to the right resulting in an exhaust cycle for combustion cylinder 518b and intake of charge air in combustion chamber 518a. Piston 506b driven to the left by rod 510b creates a compression stroke for combustion chamber 518c. Active control valves 530a and 532b are in a first neutral position directly connecting displacement compartments 522a and 522c through conduit 523b. A reduction in pressure in displacement compartment 522c due to motion of the piston to the left results in a reduced pressure in displacement compartment 522a assisting in transition of piston 506a to the right.

In the fourth firing stroke commencing with combustion of the charge mixture in combustion chamber 518c as shown in FIG. 5D, piston 506b is driven to the right with displacing surface 520c displacing the working gas in displacement compartment 522c. Active valve 530b is now in a second position connecting displacement compartment 522c to supply manifold 524 which provides the working gas to the inlet of turbine 534. The working gas discharged from the turbine is received in return manifold 528. Active valve 532a is now in a second position connecting displacement compartment 522a to the return manifold which returns the working gas to displacement compartment 522a. Entry of pressurized working gas into displacement compartment 522a causes piston pair 506a and 508a to be driven to the left resulting in compression of charge air in combustion chamber 518a. Piston 508b driven to the right by connecting rod 510b creates the exhaust stroke in combustion chamber 518d. Active valves 530a and 532b are in a second neutral position directly connecting displacement compartments 522d and 522b through conduit 523b. Reduction in pressure in displacement compartment 522d resulting from motion of piston 508b to the right causes a reduction in pressure in displacement compartment 522b assisting in motion of piston 508a to the left.

The linear engines disclosed by the embodiments described provide minimal radial forces on the piston assembly therefore lubrication requirements are simplified and wear on the friction surface is reduced. Operation with piston rings in a manner known to those skilled in the art of internal combustion engines is therefore possible. However, less lubricant is required due to the lower friction forces compared with conventional crank engines. Additional efficiency increase is available through use of the working gas as a pressurant for air bearings.

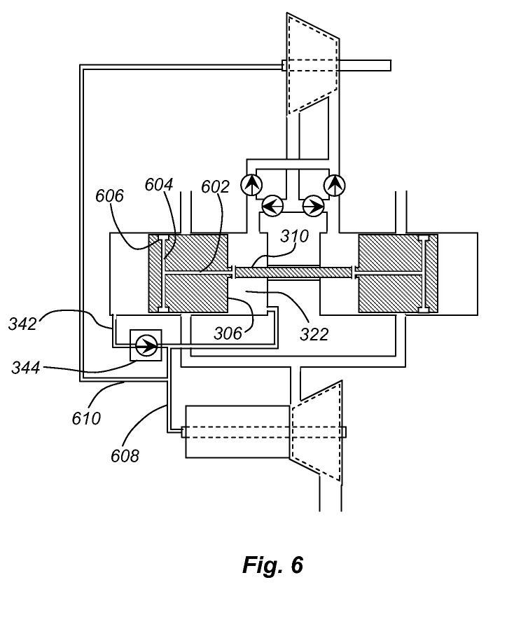

FIG. 6 schematically demonstrates additional elements to provide air bearings for moving components in the system described in the embodiment of FIG. 3. Working gas from the displacement compartments 322 is provided through cavities 602 to capillaries 604 and recesses 606 in the pistons 306. For the embodiment shown, rod 310 is rigidly interconnected integral to the pistons allowing cavity 602 to be present in the rod. In alternative embodiments one or more cavities in the compression working surface of the piston provide working gas to the capillaries. The gas bearings in the present embodiment operate in the conventional fashion. The pistons are normally concentric with the cylinders with an even gap. Radial motion of the piston results in the piston approaching the cylinder wall on one side and receding from the cylinder wall on the opposing side. The flow of gas from the air bearing ports on the side of the piston approaching the cylinder wall is restricted by the closing gap resulting in a pressure increase which pushes the piston away from the cylinder wall preventing it from contacting the cylinder. Similarly the pressure on the opposing side where the piston is receding from the cylinder wall is reduced by the widening gap allowing the piston to be returned to the center line. In alternative embodiments the air bearing recesses reside in the cylinder wall substantially adjacent the displacement face of the piston to avoid interaction with the inlet and outlet ports for the combustion cylinder. In certain embodiments additional axially distributed air bearing ports are provided to further stabilize the pistons. Pressurized working gas from the displacement compartments is also provided through conduits 608 and 610 to air bearings in the electrically driven compressor or turbocharger and turbine respectively. The air bearing is provided with gas at near PCP, therefore the high pressure of the combustion/work cycle will not interfere with the operation of the air bearing since actual PCP exists in the combustion chamber for a short time only. The design of the bleed conduit 342 and conditioning unit 344 is such that a supply of replacement gas is available to replace the continual loss of gas from the air bearings to the combustion chambers.

A supplemental pressurant supply to provide working gas for startup conditions may be provided, as will be described in greater detail subsequently. The additional use of the pressurized working gas for air bearings in the reciprocating and rotating components substantially eliminates the requirement for oil lubrication in the system.

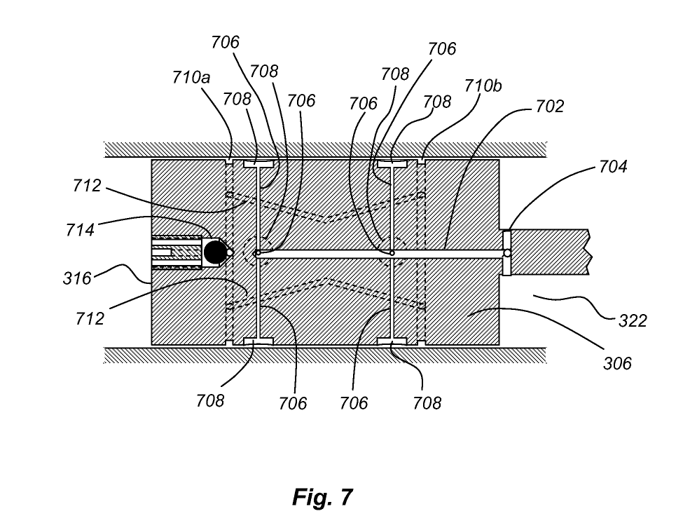

FIG. 7 demonstrates an exemplary internal conduit structure for a piston as disclosed above to provide working gas distribution for the gas bearing. A cavity 702 in piston 306 receives working gas from displacement compartment 322 through a hole 704 in the rod. The working gas is then distributed through capillaries 706 to recessed gas pads 708 in the pistons. Circumferential spacing of the bearing cavities and the associated supply conduits is exemplary in the embodiment shown and is determined based on the piston mass and working gas pressures in an actual system. Circumferential collection channels 710a and 710b are machined in the piston outboard of the bearing cavities and interconnected with collection conduits 712 which communicate with combustion surface 316 of the piston through a check valve 714. The lower average pressure of the combustion chamber provides a net negative pressure between the bearing cavities and collection channels to assure working gas flow through the bearing system. The volume of conduits 712 is designed to accept working gas flow while check valve 714 is closed during a part of the power stroke. Alternatively, an additional volumetric cavity can be added for this purpose.

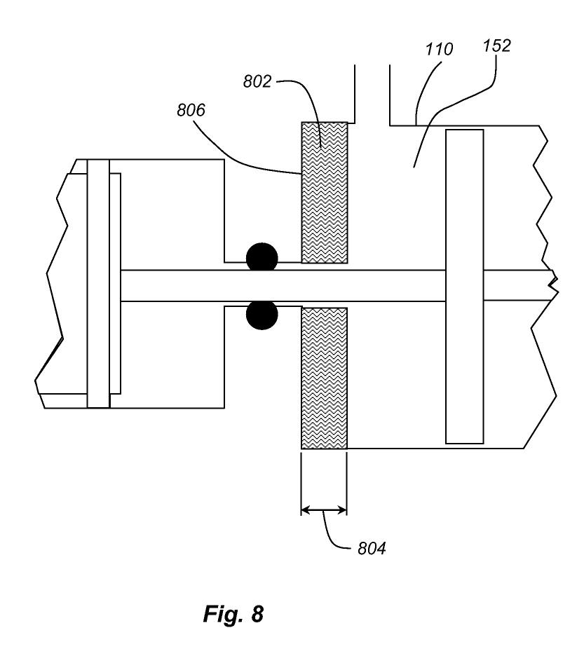

The linear combustion engine disclosed for the embodiments herein operates with oscillating reciprocation created by alternate firing of the two combustion chambers in the two-stroke embodiments. In normal operation, firing of the combustion chamber on the opposing cylinder occurs prior to any bottoming of the piston in the initially firing cylinder. If a failure condition should occur wherein a chamber fails to fire, momentum of the integrated piston assembly could result in damage to the system. As shown in FIG. 8 a plenum 802 is provided in the end portion 804 of each displacement compartment 152 in the displacement cylinder 110 for the embodiment disclosed in FIG. 1. The plenum extends beyond the working gas supply and return ports in the displacement compartment 152. Approach by the displacement piston to one longitudinal face beyond the working gas ports creates a closed volume resulting in a pressure gradient in the associated plenum which increases as the displacement piston approaches contact with the longitudinal face. Because the pressure in the plenum 802 is at or near PCP, a strong force is available to slow the piston assembly and to achieve a full stop in a short distance. The pressure pad created in the plenum prevents contact of the displacement piston with the end wall 806 and additionally prevents contact of the opposing piston with the cylinder head. For the embodiments of the invention disclosed in FIG. 2-6 the plenum described is provided adjacent the longitudinal face of the displacement compartment of each cylinder for reaction with the displacing surface of each piston.

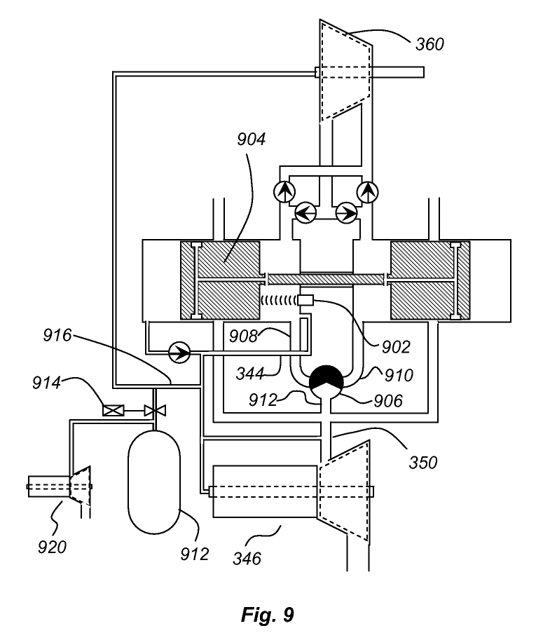

As shown in FIG. 9 embodiments of the present invention may incorporate additional operating elements to facilitate engine and system function. A position sensor 902 is operatively connected to the piston assembly 904. In alternative embodiments position sensor 902 may employ, without limitation, contact or non-contact technologies such as optical, magnetic, inductive, capacitive, ultrasound, vibration, mechanical or Hall Effect sensing technologies.

Starting of the engine for the embodiments disclosed does not require a starter. Starting is accomplished by determining the piston assembly location based on the position sensor indication, determining which piston is closest to the maximum compression point, injecting the cylinder with fuel for cold start rich mixture with the amount of air calculated to be in the cylinder and igniting with the associated sparkplug. Less than full fuel charge for the first several strokes may be employed to bring the engine online at full operating capacity. Stopping the engine leaning the fuel in the mixture for several strokes to reduce the energy input to the piston assembly for a reduction in the energy absorption required by the pressure pad plenum associated opposite the first unfired cylinder. In other exemplary starting sequences if it can not be ascertained if unburned combustion charge remains in the combustion cylinder(s) after prior engine shut down, starting may be performed using techniques such as a linear electric motor operably connected to the rod, pneumatic force applied to the displacement volumes while inactivating the directional valves or a mechanical starter motor. For additional control of the pressure in the displacement compartments a multiposition controllable valve 906 may be connected through conduits 908 and 910 to the displacement compartments and through conduit 912 to the inlet manifold 350. Valve 906 may be controlled for pressure equalization between the displacement compartments or introduction of pressurized air from the electrically driven compressor 346 to assist in the starting sequence.

For the embodiment shown in FIG. 6 wherein the air bearings are employed, a charge tank 912 may be employed as shown in FIG. 9 to introduce pressurized gas into the system for air bearing activation prior to engine start. An electronically controlled valve 914 and connecting conduit 916 from the working gas compartments to the charge tank may be controlled to allow working gas at near PCP to be introduced into the charge tank during operation of the engine and closed prior to commencing the stopping sequence thereby retaining operating pressure. Similarly, the check valve working gas extraction conduit, 142, 242a, 242b and 344 in the various embodiments described, may be controlled to reduce differential opening pressure during startup for charging of the working gas volumes or to create maximum pressure in the working gas volume during shutdown for storage purposes. Prior to engine start valve 914 is opened to provide gas pressure through the working gas compartments to supply the air bearing system.

In various embodiments, a supplemental charge tank 912 using air, CO₂, Nitrogen or other pressurant may be employed for initial pressurization of the working gas volumes or for operation of the system in a closed cycle by providing working gas without drawing combustion gas from the combustion cylinders. A separate compressor or supercharger 920 or other gas source may be employed for filling and pressurizing the supplemental charge tank 912.

Additional efficiency is created in the embodiments disclosed herein through the use of acoustic ducting for the supply and return manifolds to the turbine. Dimensioning of the supply manifold and return manifold to obtain a standing wave in the manifolds compensates for oscillating pressure introduced into the supply manifold by the working gas in the displacement compartments as the pistons reciprocate. Operation of the linear engine at a substantially constant frequency allows optimizing of the acoustic ducting with a fixed geometry. Damping of the pressure oscillations allows substantially constant inlet pressure to be provided to the turbine. Use of acoustic ducting for the inlet and outlet ports in the combustion chambers for the embodiments disclosed is also employed in the conventional manner for two-stroke engines to provide additional combustion charge compression and noise reduction. In alternative embodiments, accumulator volumes are provided in the supply and return manifolds to reduce variation in the gas flow to the turbine.

A method for operating a turbine is achieved in the disclosed embodiments by combusting a charge in a cylinder with a piston, displacing a working gas with the piston and circulating the working gas through a turbine.

As an example, the method for power generation is achieved in the disclosed embodiments by combusting a charge in a cylinder and using combustion pressure in the cylinder to displace a working gas through a displacement volume. In one version of the method a portion of the combusted charge is extracted as the working gas. In a second version of the method a piston in the cylinder is displaced by the combustion pressure for displacement of the working gas. The combustion pressure may be used to reciprocate a displacement piston in a cylinder for displacing the working gas with the piston reciprocation. A turbine is then rotated by the working gas and power is extracted from the turbine shaft rotation.

Additional alternative embodiments of the current invention employ a conventional cranked engine as the internal combustion section operating with the pressure sumps converted as displacement compartments where the compressed working gas is flowing in a closed cycle to a turbine. Such a configuration is useful when a conventional engine that is in mass production or that already exists in large supply is used to generate electricity. The gas driven turbine achieves high rotational speed that enables the use of a high frequency, small and light electrical generator as previously described. An exemplary preferred electrical generator will operate at 15,000 rpm or greater.

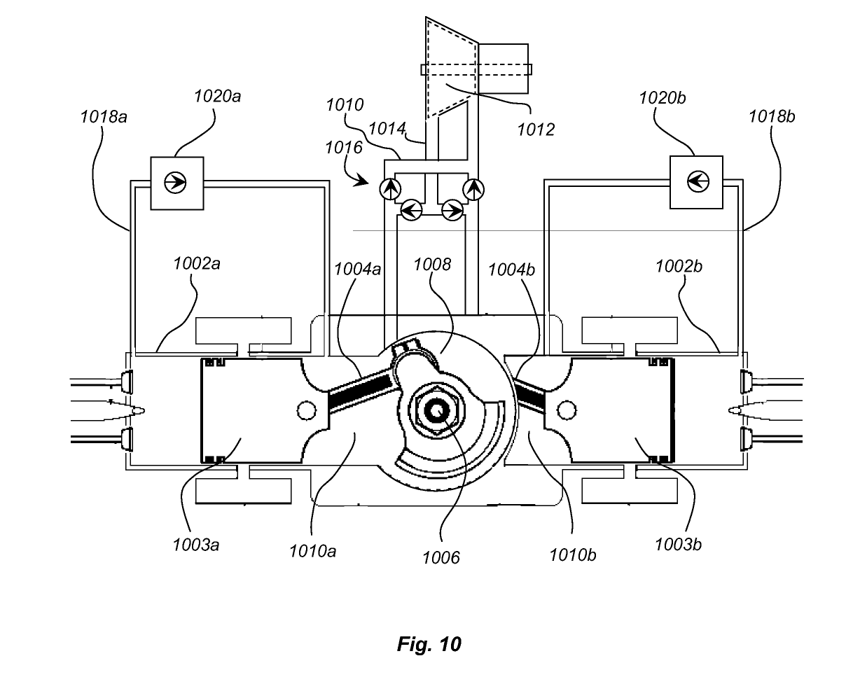

An exemplary embodiment is shown in FIG. 10 wherein a first combustion cylinder 1002a and a second combustion cylinder 1002b containing pistons 1003a and 1003b are arranged axially offset to allow connecting rods 1004a and 1004b to interconnect to a crank shaft 1006 which extends through a wall 1008 separating displacement compartments 1010a and 1010b. As previously described with respect to FIG. 3, the displacement compartments associated with each cylinder provide working gas through a supply manifold 1010 to a turbine 1012. Return manifold 1014 returns working gas to the displacement compartments. Directional flow valves 1016 provide unidirectional flow of the working gas. As with the previously disclosed embodiments, working gas for the displacement compartments is provided through bleed conduits 1018a and 1018b to conditioning units 1020a and 1020b for introduction of the gas into the displacement compartments.

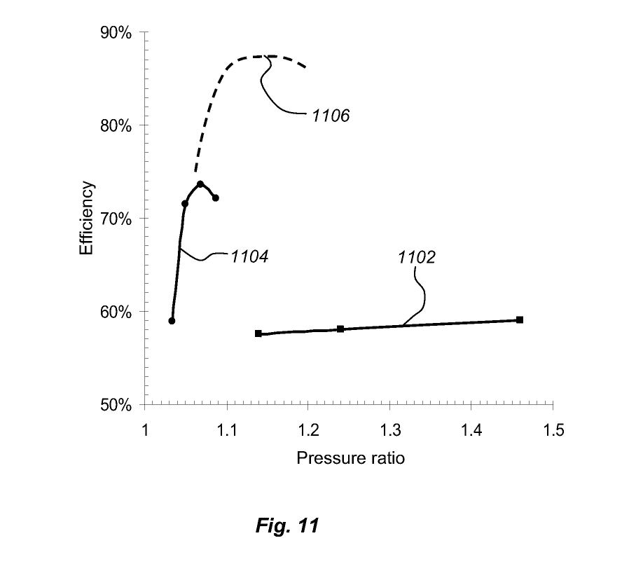

The turbine operating in embodiments such as those described can be highly efficient based on the high pressure of the system and the low pressure differential. As previously described, with conditioning of the working gas or a closed loop system, the turbine is also able to operate at essentially ambient temperatures allowing great flexibility in choice of materials. FIG. 11 shows an example of performance of a turbine employed with an exemplary embodiment. The turbine has a 31 mm diameter with a configuration comparable to a turbine of the KP31 turbocharger produced by BorgWarner Turbo Systems. Line 1102 is exemplary data for the turbine when operating with an outflow open to the atmosphere (0.1 MPa) as in a normal turbocharger application. Line 1104 employs experimentally measured data for the same turbine with outflow pressure raised to ˜1 MPa comparable to pressures at which the embodiments described operate and operation with a range of pressure ratio between about 1.03 and 1.1. Achieved efficiency of 73.6% at a pressure ratio of 1.069 is demonstrated. Dotted line 1106 represents the theoretically expected performance of turbine designed specifically for conditions in implementations of the exemplary embodiments with high pressure (close to PCP) and with estimated efficiency of approximately 85-90% at a pressure ratio of around 1.15. The operation of the turbine with working gas at high pressure and low pressure ratio between inlet and outlet as tested was shown to achieve higher efficiency than the same turbine operated as originally designed with the outlet open to the atmosphere. Testing was conducted with turbine speeds of up to 85,000 rpm. For turbine diameters amenable to 1 kW of output power, turbine speed will be approximately 150,000 rpm while at larger turbine diameters for output power of approximately 100 kW a turbine speed of about 15,000 rpm is expected as determined from calculations based on O. E. Balje, Turbomachines, John Wiley & Sons, 1981.

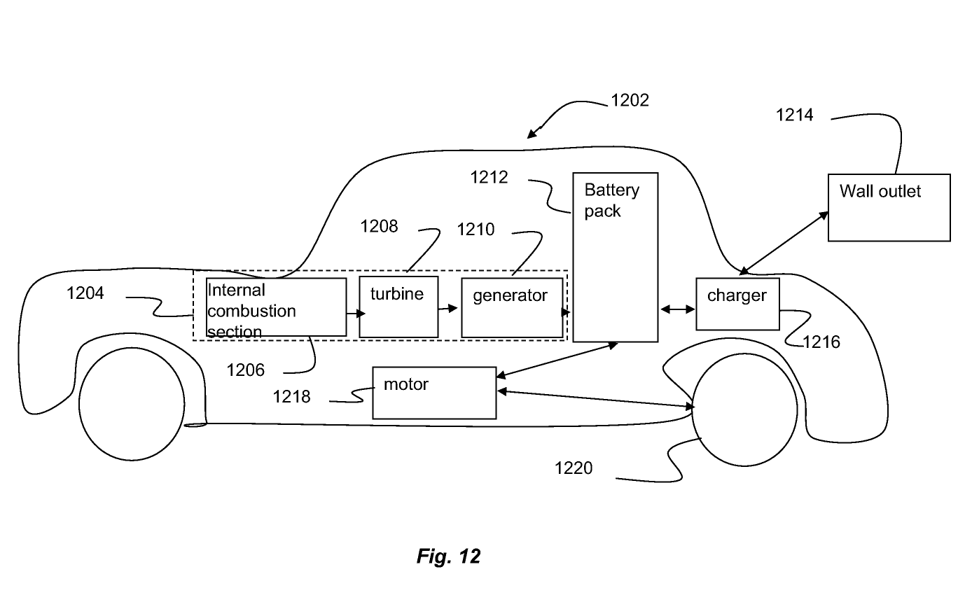

While the embodiments described herein may be employed for direct shaft power generation from the turbine or electrical power generation through connection with a generator for a myriad of uses, a particularly effective use of the inventive system will be in hybrid electric vehicles. FIG. 12 shows an embodiment of a hybrid car 1202 using an internal combustion turbo-generator employing one of the previously described embodiments with an engine 1204 having a combustion section 1206 operating on a displacement volume 1207 circulating working gas to the turbine 1208 which drives an electric generator 1210. The generator provides power to a battery pack 1212 which may also be directly connected to an electrical grid using “plug in” capability of an external wall outlet 1214 through a two-way charger 1216. One or more electric motor-generators 1218 then provide power and braking to the wheels 1220 of the car directly or through conventional transmission coupling as known in the art.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An engine comprising:
a displacement volume for a working fluid;
a turbine interconnected to the displacement volume;
an internal combustion section having at least one piston housed in a combustion cylinder with motion of said piston in reaction to combustion of a charge displacing said working fluid in the displacement volume for flow through said turbine.

2. An engine as defined in claim 1 wherein said working fluid is a working gas pressurized above about 1 MPa.

3. An engine as defined in claim 1 wherein said displacement volume comprises:
a first displacement compartment and a second displacement compartment;
a supply manifold connected for receiving displaced working fluid alternately from said first and second compartments and connected to an inlet of the turbine;
a return manifold connected to an outlet of the turbine and alternately returning working fluid to said second and first compartments.

4. An engine as defined in claim 1 said internal combustion section comprises:
first and second pistons housed in first and second combustion cylinders respectively;
first and second displacement compartments, said first and second pistons powering a first displacing surface for displacement of working fluid in said first compartment and a second displacing surface for displacement of working fluid in said second compartment.

5. An engine as defined in claim 1 further comprising a conduit interconnecting a combustion chamber associated with at least one of said pistons with said displacement volume.

6. An engine as defined in claim 1 wherein said at least one piston comprises two pistons and a linkage connecting said two pistons for complementary reciprocating motion.

7. An engine as defined in claim 6 wherein said two pistons are mounted for motion in opposing directions along a common axis and said linkage comprises a rod parallel to said axis.

8. An engine as defined in claim 3 wherein said supply manifold incorporates unidirectional flow valves for extracting working gas from the first and second compartments and said return manifold incorporates unidirectional flow valves for admitting working gas to said first and second compartments.

9. An engine as defined in claim 3 wherein said supply manifold incorporates controlled valves for extracting working gas from said first and second compartments and said return manifold incorporate controlled valves for admitting working gas to said first and second compartments.

10. An engine as defined in claim 5 further comprising a gas conditioning system integrated with said conduit for conversion of combustion products from the combustion chamber into working gas, said gas conditioning system incorporating a unidirectional flow valve preventing backflow into the combustion chamber.

11. An engine as defined in claim 6 wherein a backside of a first of said two pistons comprises a first displacing surface and a backside of a second of said two pistons comprises a second displacing surface and wherein said first and second combustion cylinder sumps associated with said first and second pistons comprise first and second compartments for said working fluid.

12. An engine as defined in claim 6 further comprising:
a displacement cylinder; and,
a displacement piston, said linkage linking said displacement piston to said two pistons.

13. An engine as defined in claim 6 wherein the engine operates with a two-stroke cycle.

14. An engine as defined in claim 13 further comprising a compressor providing charge air to the combustion cylinders.

15. An engine as defined in claim 6 wherein said working fluid is a working gas and further comprising capillaries communicating between said displacement volume and the radial periphery of each of the pistons for transfer of said working gas as an air bearing.

16. An engine as defined in claim 2 further comprising at least one capillary communicating with the displacement volume to provide working gas for an air bearing.

17. An engine as defined in claim 2 further comprising compressor to provide said working gas.

18. An engine as defined in claim 1 further comprising a high frequency electrical generator interconnected to said turbine, said generator operating at above 15,000 rpm.

19. A power generation system comprising:
a first combustion cylinder housing a first piston and providing a first combustion chamber;
a second combustion cylinder housing a second piston and providing a second combustion chamber, the first and second pistons interconnected for reciprocating motion induced by alternate firing of the first combustion chamber and second combustion chamber;
a displacement cylinder housing a displacement piston interconnected to said first and second pistons, said displacement piston segregating said displacement cylinder into a first compartment and a second compartment;
a turbine providing power through a rotating shaft;
a supply manifold connected to said first and second compartments to supply working gas to an inlet of said turbine;
a return manifold connected to said first and a second compartments to return said working gas from an outlet of said turbine.

20. The power generation system as defined in claim 19 wherein:
said supply manifold incorporates unidirectional flow valves for extracting working gas from said first and second compartments.
said return manifold incorporates unidirectional flow valves for admitting working gas to said second and first compartments.

21. The power generation system as defined in claim 19 wherein:
said supply manifold incorporates active valves for extracting working gas from said first and second compartments.
said return manifold incorporates active valves for admitting working gas to said second and first compartments.

22. The power generation system as defined in claim 19 further comprising:
a conduit interconnecting at least one of said combustion chambers associated with one of said pistons with at least one of said first or second compartment;
a gas conditioning system integrated with the conduit for conversion of combustion products from the combustion chamber into working gas, said gas conditioning system incorporating a unidirectional flow valve preventing backflow into the combustion chamber.

23. The power generation system as defined in claim 19 further comprising a high frequency electrical generator operating at a frequency above 15,000 rpm interconnected with said turbine.

24. The power generation system as defined in claim 19 wherein said first and second piston are linearly interconnected with a rod and said displacement piston is connected to said rod.

25. A power generation system for a hybrid car comprising:
a first combustion cylinder housing a first piston and having a combustion chamber associated with a combustion face of the first piston and a first compartment associated with a displacing surface of the first piston;
a second combustion cylinder housing a second piston and having a combustion chamber associated with a combustion face of the second piston and a second compartment associated with a displacing surface of the second piston;
a turbine providing power through a rotating shaft;
a supply manifold connected to said first and second compartments to supply working gas to an inlet of said turbine;
a return manifold connected to said first and a second compartments to return said working gas from an outlet of said turbine.

26. The power generation system as defined in claim 25 wherein:
said supply manifold incorporates unidirectional flow valves for extracting working gas from said first and second compartments; and,
said return manifold incorporates unidirectional flow valves for admitting working gas to the first and second compartments.

27. The power generation system as defined in claim 25 wherein:
said supply manifold incorporates active valves for extracting working gas from said first and second compartments; and
said return manifold incorporates active valves for admitting working gas to said first and second compartments.

28. The power generation system as defined in claim 25 further comprising:
a conduit interconnecting a combustion chamber for one of the pistons with at least one of the first or second compartment;
a gas conditioning system integrated with the conduit for conversion of combustion products from said combustion chamber into working gas; and,
a unidirectional flow valve preventing backflow into said combustion chamber.

29. The power generation system as defined in claim 25 further comprising a high frequency electrical generator operating at above 15,000 rpm interconnected with said turbine.

30. A power generation system comprising:
a first combustion cylinder housing a first piston and having a combustion chamber associated with a combustion face of the first piston and a first compartment associated with a displacing surface of the first piston;
a second combustion cylinder housing a second piston connected to the first piston and having a combustion chamber associated with a combustion face of the second piston and a second compartment associated with a displacing surface of the second piston;
a third combustion cylinder housing a third piston and having a combustion chamber associated with a combustion face of the third piston and a third compartment associated with a displacing surface of the third piston;
a fourth combustion cylinder housing a fourth piston connected to the third piston and having a combustion chamber associated with a combustion face of the fourth piston and a fourth compartment associated with a displacing surface of the fourth piston;
a turbine providing power through a rotating shaft;
a supply manifold alternately connected to said first, second, third and fourth compartments to supply working gas to an inlet of said turbine;
a return manifold alternately connected to return said working gas from an outlet of said turbine, working gas received at said inlet from said first compartment being returned to said third compartment, working gas received at said inlet from said second compartment being returned to said fourth compartment, working gas received at said inlet from said third compartment being returned to said first compartment and working gas received at said inlet from said fourth compartment being returned to said second compartment.

31. A power generation system comprising:
a first combustion cylinder housing a first piston;
a second combustion cylinder housing a second piston, the first and second pistons linearly interconnected by a first rod for reciprocating motion;
a third combustion cylinder housing a third piston;
a fourth combustion cylinder housing a fourth piston, the third and fourth pistons linearly interconnected by a second rod for reciprocating motion, the first and second piston pair and the third and fourth piston pair being aligned;
two displacement cylinders symmetrically displaced from the combustion cylinders, each housing a displacement piston connected to the first and second rod, said displacement piston segregating each displacement cylinder into a first compartment and a second compartment;
a supply manifold connected to said first and second compartments to supply working gas to an inlet of a turbine;
a return manifold connected to said first and a second compartments to return the working gas from an outlet of said turbine.

32. A method for power generation comprising:
combusting a charge in a cylinder to drive a piston;
using the piston motion to displace a working fluid;
circulating the displaced working fluid through a turbine.

33. The method of claim 32 wherein said working fluid is working gas.

34. The method of claim 33 wherein said working gas is pressurized at or above 1 MPa.

35. The method of claim 34 further comprising:
extracting a portion of the combusted charge at near peak combustion pressure (PCP) as said working gas.

36. The method of claim 32 wherein said turbine drives an electrical generator operating at a speed of greater than 15,000 rpm.

37. The method of claim 32 wherein the turbine operates at a pressure ratio of less than 1.5.

38. A method for operating a turbine comprising:
combusting a charge in a cylinder with a piston;
displacing a working gas with the piston;
circulating said working gas through a turbine.

39. A method for power generation comprising:
combusting a charge in a cylinder; and
using combustion pressure in the cylinder to displace a working gas through a displacement volume.

40. The method of claim 39 further comprising:
extracting a portion of the combusted charge as said working gas.

41. The method of claim 40 wherein a piston in said cylinder is displaced by the combustion pressure for displacement of said working gas.

42. A method for power generation comprising:
combusting a charge in a cylinder;
reciprocating a piston in said cylinder with the combustion pressure;
displacing a working gas with said piston reciprocation; and
rotating a turbine with said displaced working gas.

43. The method of claim 42 further comprising:
extracting a portion of the combusted charge as a working gas.

44. A method for operating a turbine comprising
rotating said turbine with displaced working gas, where
said working gas is confined to a closed cycle;
the pressure of said working gas at the turbine outlet is higher than 1 MPa, and
the ratio of the pressure of said working gas between said turbine inlet and outlet is lower than 1.5.

45. A hybrid car comprising:
an engine having a displacement volume for a working fluid;
a turbine interconnected to the displacement volume;
an internal combustion section having at least one piston housed in a combustion cylinder with motion of said piston in reaction to combustion of a charge displacing said working fluid in the displacement volume for flow through said turbine;
an electrical generator connected to said turbine;
a battery pack connected to said electrical generator and receiving electrical power from said electrical generator;
a motor connected to said battery pack for power to drive at least one wheel of said hybrid car.
